(19) United States
(12) Patent Application Publication
(10) Pub. No.: US 2013/0326878 A1
(43) Pub. Date: Dec. 12, 2013

(54) PRODUCTION OF INDIVIDUAL DENTAL PROSTHESES VIA CAD/CAM AND RAPID MANUFACTURING / RAPID PROTOTYPING BASED ON DATA OF THE SITUATION IN THE MOUTH OBTAINED BY DIGITAL MEANS

(71) Applicant: Heraeus Kulzer GmbH, Hanau (DE)

(72) Inventors: Uwe BOEHM, Hanau (DE); Klaus RUPPERT, Maintal (DE); Mario BEYER, Bad Homburg (DE)

(21) Appl. No.: 13/914,748

(22) Filed: Jun. 11, 2013

(30) Foreign Application Priority Data
Jun. 11, 2012 (DE) 10 2012 011 371.4

(51) Int. Cl. A61C 13/00

(52) U.S. Cl. CPC A61C 13/0004; A61C 13/0019
USPC 29/896.1

(57) ABSTRACT

Summary

Methods for the production of complete or partial prostheses involve, firstly A) provision of 3D data of the situation in the mouth in the edentulate or partly toothed state; B) digital designing of the denture base for lower and upper jaw each; C) digital positioning of virtual teeth with appropriate occlusion and a tooth shape selected according to aesthetic criteria, in the case of complete prostheses, D1) production of the dental arch using an automated method from the groups of layer-building and of material-removing methods; and D2) production of the denture base using an automated method from the groups of layer-building and of material-removing methods; and, in the case of partial prostheses; D1) production of the dental arch using an automated method from the groups of layer-building and of material-removing methods; and D2) production of the support structures or fastening elements using an automated method from the groups of layer-building and of material-removing methods.

The invention relates to a method for automated production of dental prostheses, in particular the production of individual dental prostheses by means of CAD/CAM and rapid manufacturing/rapid prototyping based on data of the situation in the mouth obtained by digital means.

### BACKGROUND

Full or partial dentures are being produced according to basically known methods. These include, e.g., the conventional methods involving powder/liquid technology that have been known for a long time and are described in the literature (e.g. EP 1 243 230 A2, U.S. Pat. No. 6,881,360 B2 and “Dental Materials” in: Ullmann's Encyclopedia of Industrial Chemistry, Copyright 2002 by Wiley-VCH Verlag).

In general, three different main classes of materials for the production of complete dentures are known. These are polymethylmethacrylate (PMMA)-based two component materials [commercially available as Palapress, Paladur (Heraeus Kulzer, DE), SR 3/60® Quick (Ivoclar, LI), Degupress® (Degussa-Hüls, DE)]; hot-curing materials [commercially available, e.g., as Paladon® 65 (Heraeus Kulzer, DE), SR 3/60®, SR Ivocap® (Ivoclar, LI), Lucitone® (Dentsply, US)] and injection moulded masses for thermoplastic processing.

Thermoplastic materials are heated and injected into a hollow space, usually through an injection moulding method. A known method called “Polyapress®” is distributed, amongst others, by Bredent, Senden (DE). There have been numerous attempts to use polymers such as PVC, polyurethane, polyamide or polycarbonate (Ullmann's loc. cit. 5.1.5. Other Denture Resins.)

Moreover, there are methods that are based on light- or microwave-cured 1-component materials (e.g. Eclipse made by DeguDent; (Ullmann's loc. cit. 5.1.3. Light-Cured Polymers, 5.1.4. Microwave-Cured Polymers).

Moreover, manual techniques for building-up layers are known in dental engineering. These are used in combination with light-curing materials in most cases, for example for veneering metal crowns or production of a prosthesis. The advantages of said methods include the level of control over the procedure and the ability to vary the colours in order to attain aesthetically pleasing dental work.

DE 10 2009 056 752 A1 describes the separate production of dental arch and denture base/gingiva imitation. The parts are designed to be glued to each other subsequently: In particular a plastic or ceramic dental arch with colour layers is produced therein after providing data from digital impressions or from the digitisation of a conventional functional impression with silicone. The production and fabrication of a gingiva imitation are designed to proceed concurrently. Dental arch and gingiva are then firmly connected to each other by means of established gluing methods.

The use of Rapid Prototyping¹ methods in dental engineering has also been proposed. These involve working with layers that can be polymerised (DE 101 14 290 A1, DE 101 50 256 A1) or with ink jet powder printing (U.S. Pat. No. 6,322,728 B1). ¹ Rapid Prototyping (German: schneller Prototypenbau) is a method for rapid production of sample components based on design data.

Accordingly, rapid prototyping methods are manufacturing methods aiming to implement existing CAD data directly and rapidly in work pieces, if possible without manual detours or moulds. The relevant data interface for this group of methods is the STL format. The methods that have become known by the name of Rapid Prototyping since the 1980s are usually primary forming methods that build-up the work piece in layers from shapeless or neutral-shape material utilising physical and/or chemical effects.

Continued developments in the field of cutting technology (CAD/CAM cutters) and generative fabrication technology of rapid prototyping as well as rapid manufacturing² are being introduced into prosthetics. ² The term, Rapid Manufacturing (or German term: Schnelle Fertigung), refers to methods and production procedures for rapid and flexible production of components and series' through tool-less fabrication based directly on the CAD data. The materials that are used include glass, metal, ceramics, plastics, and novel materials (such as UV-hardening sol-gel, see e.g. Multi Jet Modeling) [. . . ]

This is based on digital detection of the situation in the mouth by means of digitised impressions, whereby both direct (e.g. 3D cameras) and indirect methods (e.g. scanning of models) are generally known for this purpose. Scanning technologies such as Lava® C.O.S. of 3M Espe, Bluecam® of Sirona, Hint ELS® directScan or cara® TRIOS of by Heraeus Kulzer are commercially available. Processing of the data thus obtained in virtual articulators enables the virtual positioning of teeth that exist as a data set. This results in data sets for individual complete or partial dental prostheses. Pertinent methods are described, e.g., in EP 1 444 965 A2, together with the subsequent production of dental prostheses:

“[0012] After the work on the virtual model is completed, the transfer to the denture can proceed right away, i.e. the virtual tooth positioning data is used as the basis for production of a denture base with positioning aids for the teeth into which the respective selected pre-fabricated teeth simply need to be inserted.

The denture base can be produced directly or a casting mould can be produced for it. Conceivable methods include, for example, cutting or rapid prototyping.”

Examples of rapid manufacturing techniques include: Stereolithography (SLA), Fused Deposition Modeling (FDM), Selective Laser Sintering (building up layers by sintering powders), Selective Laser Melting (SLM, building up layers through complete melting and re-solidification of powder), 3D/Inkjet Printing.

U.S. Pat. No. 7,153,135 B1 describes said methods in detail and, in addition, such techniques as “Laminated Object Manufacturing” (including layering of ceramic green films) and “Solid Ground Curing” (curing by light of entire layers proceeding through templates, particularly well-suited for large objects). “Inkjet printing” is defined therein as a generic term that comprises both classical 3D printing (3DP) as developed at MIT and more refined methods using 2 beams (one dispensing thermoplastic material, the other the supporting wax). New generations of jet systems have numerous printing heads, e.g. 96 (as made by 3D Systems). This allows entire layers of a product to be applied in an overrun. If the cross-section of the product is too large, the machine produces several overruns next to each other.

The preceding methods are subject to constant refinement of the technology and materials used such that the initially non-satisfactory aesthetic properties are improving. In particular, it has meanwhile become feasible to not only use single, and therefore single-coloured, starting materials. For example in the production of artificial teeth, this allows for the use of multi-coloured individual building blocks or for the layers blending into each other and a natural appearance can be imitated in the final product.

It is already feasible through the CAD/CAM cutting technology, referred to as CAD/CAM hereinafter for simplicity, to process multi-coloured, layered plastic (e.g. Vita CAD-temp multicolor) or even ceramic materials (e.g. Vitablocs Triluxe) that make the finished tooth and/or the finished prosthetic work, appear very natural.

### Object of the Invention

It is the object of the invention to devise methods that can be used to further improve the automated production method. Moreover, the production of aesthetically sophisticated dental prostheses with layers of colours or colour hues or variations in transparency is to be made feasible.

### Description of the Invention

The object is met through the features of claims 1 and 2. Preferred embodiments are evident from the further claims.

The scope of the invention includes, in particular, the following methods:

1. Method for the production of a complete prosthesis comprising
A) provision of 3D data of the situation in the mouth in the edentulate state;
B) digital designing of the denture base for lower and upper jaw each;
C) digital positioning of virtual teeth with appropriate occlusion and a tooth shape selected according to aesthetic criteria;
D1) production of the dental arch using any of the methods defined above: SLA, inkjet printing, FDM, and CAD/CAM cutting from a Material-2A, 2B or 2C that is appropriate for the respective method
D2) production of the denture base using any of the methods defined above: SLA, inkjet printing, FDM, SLM, and CAD/CAM cutting from a Material-1A, 1B, 2A, 2B or 2C that is appropriate for the respective method.

2. Method for the production of a partial prosthesis comprising
A) provision of 3D data of the situation in the mouth in the partially toothed state;
B) digital design of the holding and support construct (complete denture=denture base);
C) digital positioning of virtual teeth with appropriate occlusion;
D1) production of the dental arch using any of the methods defined above: SLA, inkjet printing, FDM, and CAD/CAM cutting from a Material-2A, 2B or 2C that is appropriate for the respective method,
D2) production of the support structures or fastening elements through SLM or CAD/CAM cutting from a Material-1A or 1B, e.g. metal or high-performance plastic material.

In detail, the following materials are well-suited:

Material 1A for SLM: A member of the group of: powder-shaped substances (thermoplastic materials) or metal powder, in particular CoCrNi base alloys, noble metal-containing alloys, in particular as common in the field of dentistry, stainless steel, titanium, thermoplastic high-performance polymers such as PEEK, filled thermoplastics;

Material 1B for CAD/CAM cutting: A member of the group of: noble metals and alloys thereof, ceramics, in particular zirconium dioxide ceramics, polymers, titanium, low-melting alloys, thermoplastic high-performance polymers such as, e.g., PEEK, filled thermoplastics, EM alloys;

Material 2A for SLA: A member of the group of: light-sensitive monomer mixtures filled with inorganic substances or non-filled;

Material 2B for inkjet printing (3D printing): A member of the group of: epoxy/acrylate monomers or light-curing monomer mixtures, light-sensitive monomer mixtures, filled with inorganic substances or non-filled;

Material 2C for FDM: A member of the group of: thermoplastic high-performance polymers such as polyetheretherketone (PEEK), filled thermoplastics.

Depending on which groups of material (Material-1, Material-2) are used, the production of different products is favoured. The support structures or fastening elements of partial dental prostheses are preferably fabricated from metal or high-performance polymers. It is also feasible to produce partial prostheses in fully automated manner through coating the support structures with tooth-coloured materials.

The method is also well-suited for implant-supported partial or complete prostheses.

Another application is the replacement of defective prostheses. An individualised new prosthesis can be fabricated based on stored data of the damaged prosthesis. Obviously, this can be done either in a central facility, right in the dental technician workshop or in the dentist's office—depending on where the necessary equipment is available.

The method is obviously also well-suited for the production of removable partial prostheses.

The following methods are particularly advantageous:

Partial prosthesis, optionally implant-supported: The support construct is preferably printed by SLM and the gingiva is then also built-up in layers from suitable thermoplastic materials using Selective Laser Melting.

Dental arch: Inkjet methods are particularly well-suited for the production of dental arches for partial or complete prostheses. The multi-layered design allows for colour or transparency gradients.

Denture base: This can be built-up advantageously, preferably from polyacrylates or polymethylmethacrylate, using Selective Laser Melting.

Complete prosthesis: It is advantageous to produce dental arch and gingiva separately.

Methods that are well-suited for production of the dental arch include SLA, inkjet, SLM, and FDM and CAD/CAM cutting; whereas SLA, inkjet, and SLM are well-suited for production of the gingiva.

It is also feasible to produce single teeth or dental arches through separate build-up of an internal part that is subsequently veneered on its exterior with at least one additional material. In this context, external and internal layer can differ in transparency. This provides for natural appearance and is particularly well-suited for frontal teeth. The external layer can just as well be particularly resistant to mechanical impact or abrasion. This, in turn, is particularly well-suited for molar teeth exposed to strong strains from mastication.

In terms of technology, this can be implemented by building-up the inside of the tooth by SLA or inkjet technique. The external second material can be applied, e.g., using FDM. This allows for the provision of anti-plaque layers as well.

The advantages of the automated methods specified above include time savings, greater accuracy—the fit of the finished dental restoration - and reproducibility, for example in the replacement of defective dental prostheses.

Referring to SLM methods, it is particularly important to note that the materials used in the process are free of residual monomer since this involves only forming by melting. Likewise, using acrylates, basically only MMA-free acrylates of higher molecular weight are used. Said materials also are advantageous with respect to the occupational safety in industrial halls.

Steps D1) and D2) can be carried out on two different machines, one each for red (gingiva) and white (teeth).

Naturally, there is no wax try-in. This renders the method less expensive. Altogether, the production (from scan to try-in) is more rapid as compared to production by hand.

In the figures:

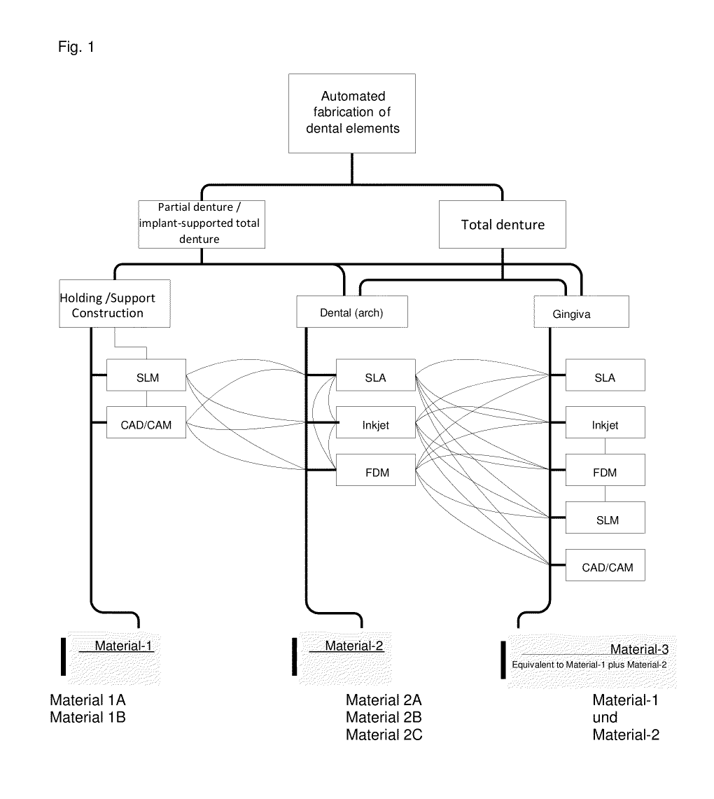

The flow diagram of FIG. 1 illustrates the options of various embodiments of the production method according to the invention and the material groups explained in the copy.

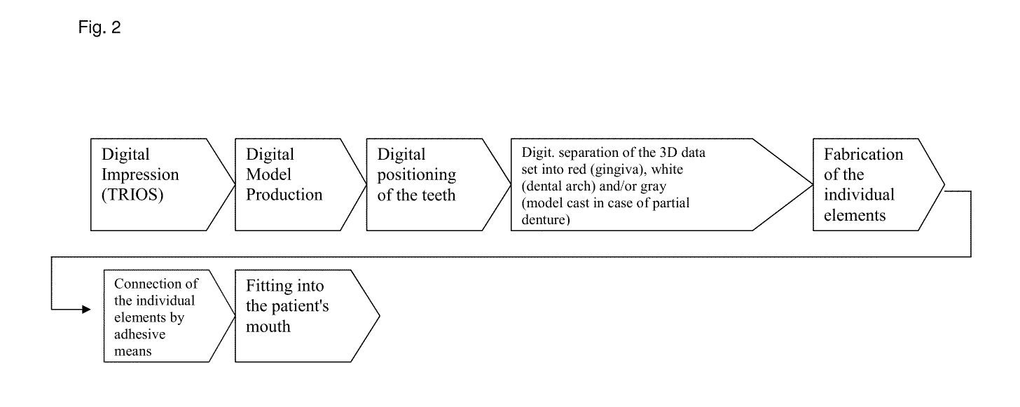

In detail, the steps of an embodiment of the method according to the invention shown in FIG. 2 are as follows:
dentist taking an impression with an intraoral scanner
generation of digital model data p1 Optional: submission of the digital model to the dental laboratory
digital positioning of the teeth
Optional: Digital separation of the 3D data set into red (gingiva), white (tooth/dental arch) or/and grey (grey denotes the inside of a veneered bridge construct or the early model cast of a, possibly implant-supported, partial prosthesis)
Fabrication of the individual elements, possibly including connecting elements
whereby the inside of the teeth or of the dental arch is produced using an automated method and at least a second material is then applied onto the inside of the teeth or of the dental arch as an external layer through an automated method (preferably the inside of the teeth (core) is produced through cutting or SLA or inkjet printing, and at least one second material is applied through FDM),
connection of the individual elements, preferably by adhesive means
optional: reprocessing, such as, e.g., grinding-in and polishing
delivery to the customer.

1. Method for the production of a complete prosthesis comprising
A) provision of 3D data of the situation in the mouth in the edentulate state;
B) digital designing of the denture base for lower and upper jaw each;
C) digital positioning of virtual teeth with appropriate occlusion and a tooth shape selected according to aesthetic criteria;
D1) production of the dental arch using an automated method from the groups of layer-building and of material-removing methods;
D2) production of the denture base using an automated method from the groups of layer-building and of material-removing methods.

2. Method for the production of a partial prosthesis comprising
A) provision of 3D data of the situation in the mouth in the partially toothed state
B) digital designing of the denture base
C) digital positioning of virtual teeth with appropriate occlusion
D1) production of the dental arch using an automated method from the groups of layer-building and of material-removing methods;
D2) production of the support structures or fastening elements using an automated method from the groups of layer-building and of material-removing methods.

3. Method according to claim 1, comprising
D1) production of the dental arch using any one of the methods, SLA, inkjet printing, FDM, and CAD/CAM cutting, each from Material-2 that is suitable for the respective method.
D2) production of the denture base using any one of the methods, SLA, inkjet printing, FDM, SLM, and CAD/CAM cutting, each from Material-1 or Material-2 that is suitable for the respective method.

4. Method according to claim 2, comprising
D1) production of the dental arch using any one of the methods: SLA, inkjet printing, FDM, and CAD/CAM cutting from a Material-1 or Material-2 that is appropriate for the respective method,
D2) production of the support structures or fastening elements using any one of the methods: SLM or CAD/CAM cutting from a Material-1 that is appropriate for the respective method.

5. Method according to claim 1, whereby the inside of the teeth or of the dental arch is produced using an automated method and at least a second material is then applied onto the inside of the teeth or of the dental arch as an external layer using an automated method.

6. Method according to claim 5, whereby the core is produced through cutting or SLA or inkjet printing.

7. Method according to claim 5, whereby the external layer is applied through FDM.

8. Method according to claim 5, whereby the inside of the teeth or of the dental arch is built-up through SLA or inkjet technique and at least a second material is then applied onto the inside of the teeth or of the dental arch as an external layer through FDM.

9. Method according to claim 1, whereby the joining of dental arch and denture base is implemented through mechanical elements, such as, e.g., guide splints, grooves, and suitable retention elements, or through gluing or form-fitting connection.

10. Method according to claim 1, whereby steps D1 and D2 are implemented by means of inkjet printing methods.

11. Method according to claim 2, whereby step D1 is implemented through inkjet printing and step D2 is implemented through CAD/CAM cutting.
